(19) United States
(12) Patent Application Publication
(10) Pub. No.: US 2012/0098209 A1
(43) Pub. Date: Apr. 26, 2012

(54) Sealing Arrangement for a Shaft

(75) Inventor: Soenke Siegfriedsen, Rendsburg (DE)

(73) Assignee: AERODYN ENGINEERING GMBH, Rendsburg (DE)

(21) Appl. No.: 13/147,113

(22) PCT Filed: Jun. 16, 2010
(86) PCT No.: PCT/DE2010/000673

§ 371 Date: Jul. 29, 2011

(30) Foreign Application Priority Data
Jun. 22, 2009 (DE) 10 2009 030 064.3

(51) Int. Cl. F16J 15/32

(52) U.S. Cl. 277/562; 277/563

(57) ABSTRACT

A sealing arrangement includes a housing component, a shaft at least partially accommodated by the housing component, and a plurality of sealing elements, which can be moved along the longitudinal axis of the shaft for sealing the intermediate space between the housing component and the shaft. The shaft includes a section that extends in the longitudinal direction of the shaft and has a shaft diameter that is tapered in steps. The sealing elements can be moved from a first position, in which a first sealing element lies against a first step, to further positions, in which additionally at least one further sealing element lies against one further step per sealing element.

The invention relates to a sealing arrangement comprising a housing component, a shaft at least partially accommodated by the housing component, and a plurality of sealing elements, which can be moved along the longitudinal axis of the shaft, for sealing the intermediate space between the housing component and the shaft.

Seals are known from a multiplicity of applications. In particular in spaces that accommodate rotating parts, for example ship shafts or rotor shafts of wind power plants, efficient sealing is of great importance so as to guarantee optimum lubrication of the bearings, in particular to prevent the lubricant from leaking and dirt from entering.

It is also known that these seals are subject to a high degree of wear due to the permanent mechanical stress by the rotating shaft and therefore must be replaced in regular intervals. To avoid a too frequent replacement of the seals which equates with a downtime of the plant containing the seals and can only be carried at high expense, it is common to provide several seals so that in the case of damage to a first seal by wear a further second seal can assume the sealing function.

As an alternative it can also be provided that each seal is assigned a second spare seal that is not held in engagement with the rotating shaft for the case of need and is additionally placed against the rotating shaft automatically.

Such a solution is for example proposed by DE 601 12 067 T2 where several sealing elements are arranged one behind the other, initially only a single first sealing element lying against the rotating shaft. The other sealing elements kept in spare are then separated from the rotating shaft by a partition that are successively released when needed. If now the first sealing element is worn to such a degree that its sealing function is no longer ensured, the sealing element next to it is released so that both sealing elements lie against the rotating shaft; however only the newly added sealing element being able to carry out the sealing function.

In this case it is however a disadvantage that the sealing elements kept in spare are under permanent tension so that it has to be feared that the sealing action of the elements kept in spare is reduced over the course of time and can no longer be performed completely when needed.

A similar principle emerges from DE 2 028 427 A from which it is known to keep in reserve a sealing element that is not arranged in the operating position, that is brought by a relative movement along the axis of the rotating shaft into contact with it, i.e. into the operating position —however without the sealing element that is kept in reserve previously lying against a partition.

As an alternative a bushing seated on the shaft can be designed such that depressions are provided on the surface of the bushing that accommodate the spare sealing elements without contacting. In the case of a relative movement between sealing element and bushing the sealing element leaves the depression and is raised slightly while being brought into contact with the bushing so that it can perform its sealing function At the same time the sealing element used previously is accommodated without contacting, by a further depression of the bushing and no longer has any influence on the tightness—a faulty sealing element is thus replaced by an unused spare sealing element.

A disadvantage of these designs is however that the first sealing element and the one following it as a spare one lie against the same location of the shaft. If wear of the seal takes place not only on the sealing element but also on the shaft, the sealing properties of the seal are inadequate despite a fully functional sealing element if the spare sealing element lies against the same location as the previous (allegedly) worn sealing element. In addition, these seal arrangements are mechanically complex and require quite a lot of space.

The object of the invention is therefore to produce a space-saving, efficient sealing arrangement that is easy to manufacture.

The object is achieved by the sealing arrangement having the features of claim 1. The sub claims specify advantageous developments of the invention.

The basic idea of the invention is to design the shaft such that the diameter along a section of the axis of the shaft is reduced in steps, the number of steps preferably corresponding to the number of sealing elements. Here the sealing elements are arranged relative to the steps such that by axially sliding the sealing elements into a plurality of positions in each case further sealing elements come to rest sealingly on in each case a further step, the further sealing elements additionally, at least relative to the previous sealing element, lying against the respectively further step.

The advantage of the invention is in particular that no sealing element can come to lie at a position previously used by another sealing element since each sealing element is assigned its own step; in addition also the position of each sealing element is changed on its step in the case of a relative movement. This effectively prevents that signs of wear occurring on the shaft can influence the sealing function of the sealing elements.

The invention is explained in more detail by exemplary embodiments that are shown in the drawings and have a particularly preferred design. In the drawings:

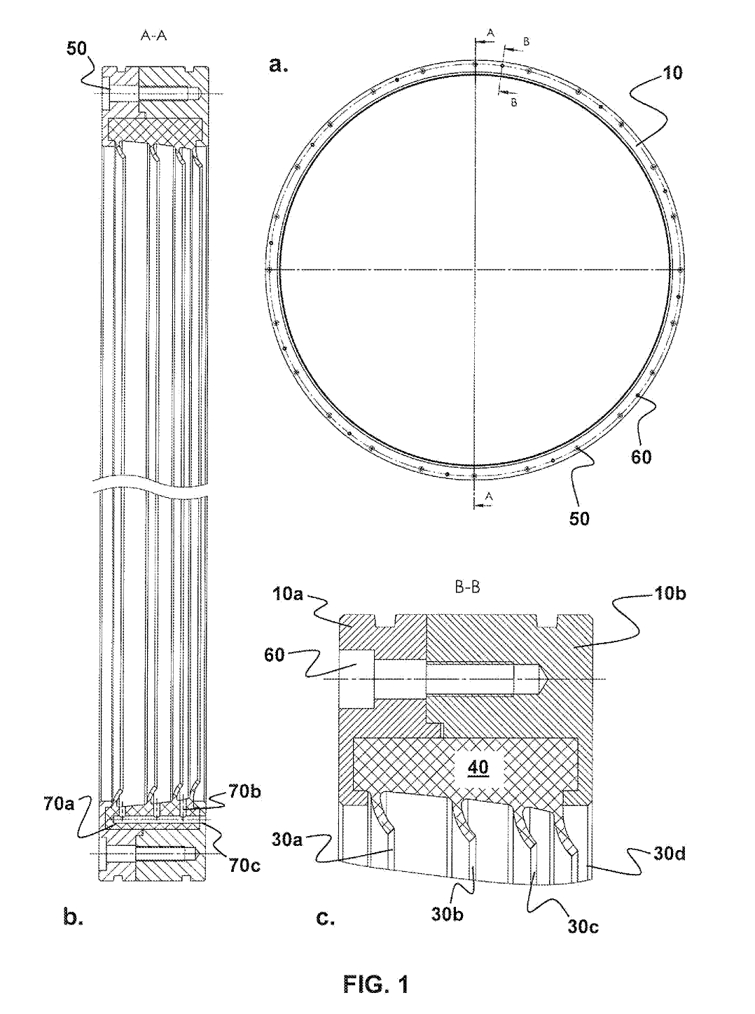

FIG. 1 shows the housing component of the inventively designed sealing arrangement according to a particularly preferred exemplary embodiment in a front view (a), a cut view along the line A-A (b), and a cut detailed view along the line B-B (c);

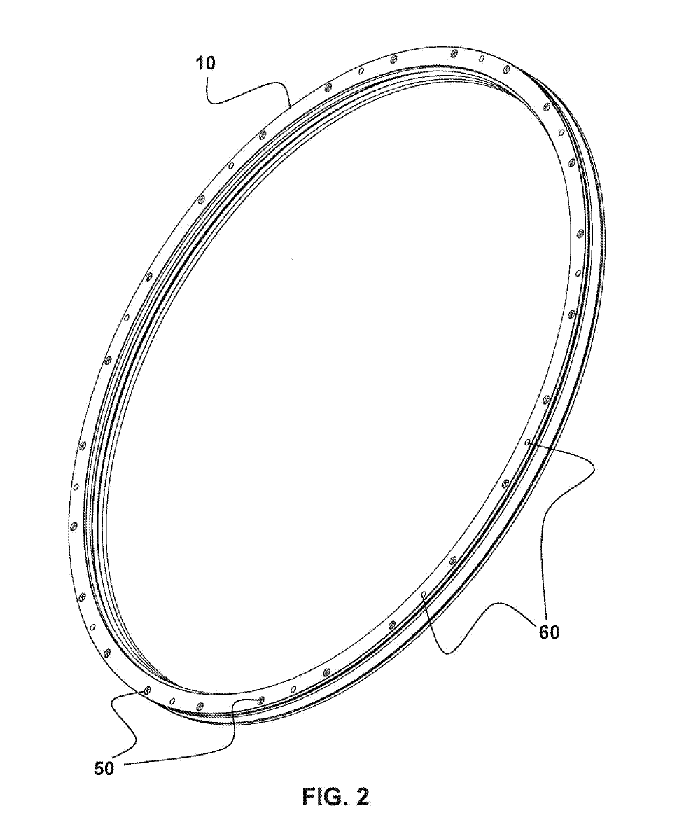

FIG. 2 shows a perspective view of the housing component of FIG. 1;

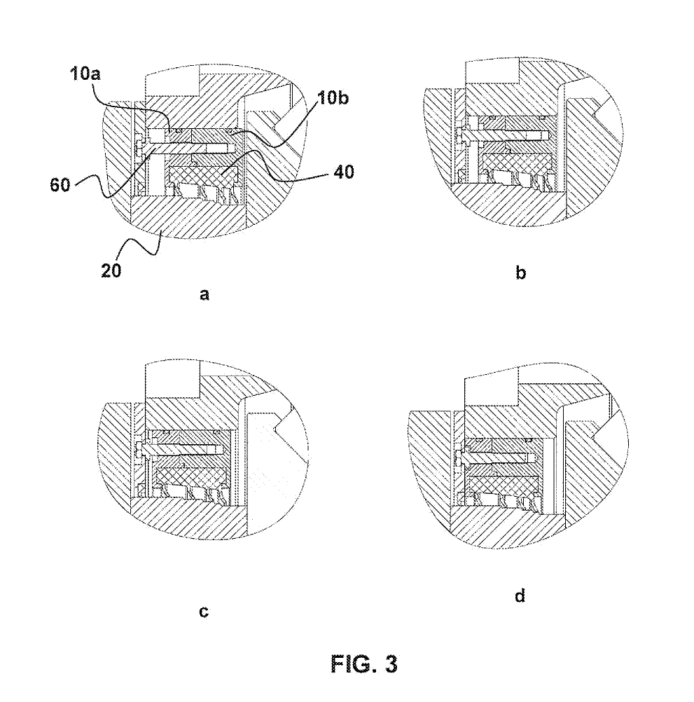

FIG. 3 shows a cut detailed view of the sealing arrangement according to the invention in four different sealing positions;

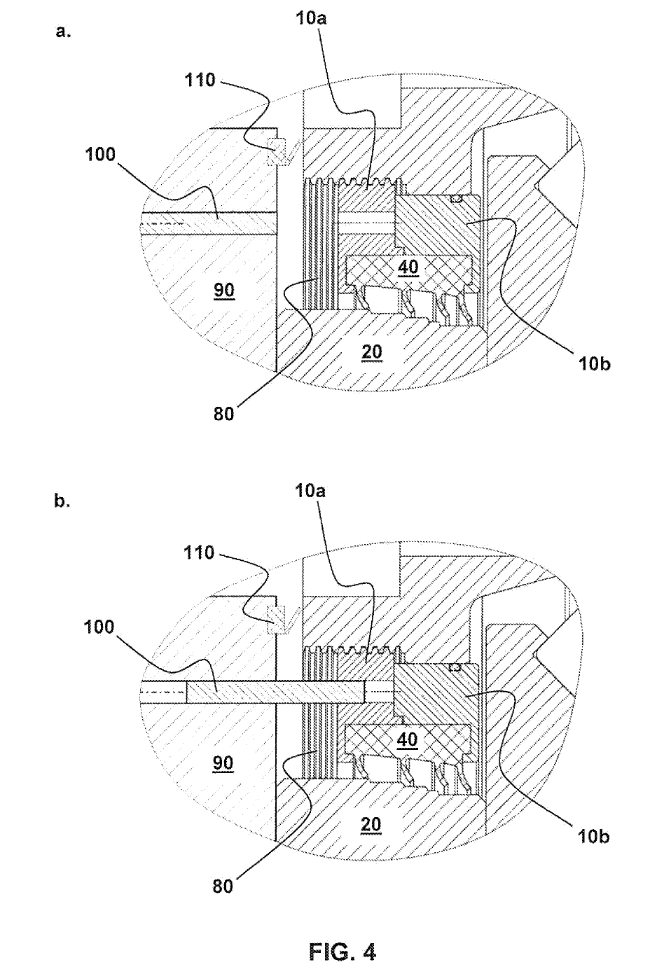

FIG. 4 shows a cut detailed view of the sealing arrangement according to a particularly preferred development of the invention; and

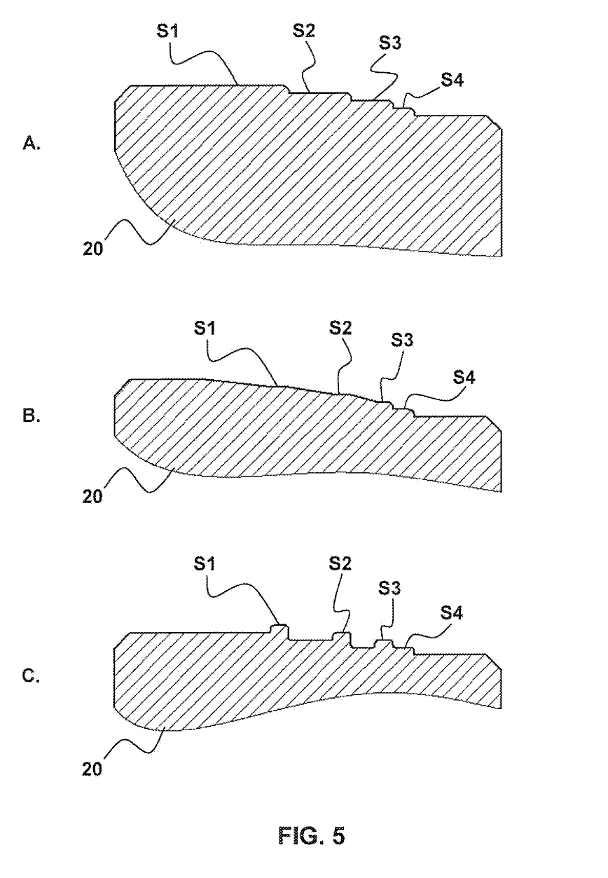

FIG. 5 shows different advantageous developments of the shaft according to the invention.

FIG. 1 shows the housing component of the inventively designed sealing arrangement according to a particularly preferred exemplary embodiment in three views, that is a front view (FIG. 1a), a cut view along the line A-A (FIG. 1b), and a cut detailed view along the line B-B (FIG. 1c).

As FIG. 1 shows, the housing component 10 is designed as a ring that accommodates on its inner side a plurality of sealing elements 30a, 30b, 30c, 30d. The sealing elements 30a, 30b, 30c, 30d designed as sealing lips are connected to a common carrier 40, the sealing elements 30a, 30b, 30c, 30d and the carrier 40 being of integral design—as shown in the example.

The sealing elements 30a, 30b, 30c, 30d can for example be manufactured from polytetrafluoroethylene (PTFE) or polyurethane (PUR). Since these plastics exhibit a high coefficient of thermal expansion it may be necessary to take further constructive measures to avoid a thermal deformation of the sealing elements 30a, 30b, 30c, 30d or of the carrier 40.

The annular housing component 10 is preferably formed from two or more rings 10a, 10b that are releasably connected by means of a plurality of fastening means 50 and that form a receptacle for the carrier 40 and fix it in the housing component 10 such that the thermal deformation of the carrier 40, likewise preferably manufactured from plastic, and of the sealing elements 30a, 30b, 30c, 30d is restricted.

As shown in Fig. lb, channels 70a, 70b, 70c are provided between the sealing elements 30a, 30b, 30c, 30d for supplying and discharging a lubricant. In particular in FIG. 1b on the lower side of the sealing arrangement it can be seen that between the sealing elements 30a, 30b, 30c, 30d channels 70b are preferably provided that open into a single channel 70a that is provided in the carrier 40 and communicates with a further channel 70c provided in the housing component. It is the object of this channel system 70a, 70b, 70c to discharge the lubricant that is supplied on the top side of the sealing arrangement through a corresponding channel system between the sealing elements 30a, 30b, 30c, 30d of the shaft 20 and to take care by the interacting channel systems that the lubricating oil is distributed uniformly so that the sealing elements 30a, 30b, 30c, 30d do not run dry.

On top of this, the housing component 10 has a plurality of positioning means 60 to position the housing component 10 in a housing in an axial direction. However the positioning means 60 that extend parallel to the axis of the shaft (shown in FIG. 3) not only serve to establish the housing component 10 in its position in the housing but in particular to shift the sealing elements 30a, 30b, 30c, 30d in their position on the shaft 20. To this end the positioning means 60 are preferably designed as threaded holes into which the screws having a screwing action with the threaded holes can be inserted, the screws being supported on a support element provided on the housing and thus being able to effect a relative movement between the housing component 10 and the shaft 20. The maintenance staff can preferably have free access to the screws from the outside of the housing so that positioning of the sealing elements 30a, 30b, 30c, 30d on the shaft 20 can take place during repair work at the plant.

In particular it makes sense to have a leakage sensor connected to a monitoring device, that is to say a sensor that detects lubricating oil that escapes from the bearing via the seal, it being possible for the escaping lubricating oil to be fed back to the tank via a leakage line. It is also advantageous to emit an alarm message when lubricating oil escapes, it being possible to simply issue a notification, as a function of the amount of oil escaping (per unit time), as to a leakage without any urgency in terms of maintenance, or an alarm, when a certain amount of oil in excess of a predetermined limit value escapes, with the urgency for example to re-adjust the seal arrangement for example by the maintenance staff.

The design that has been previously mentioned, of the housing component 10 enables an extremely compact design that can be manufactured relatively simply—as is shown in FIG. 2 in a perspective view.

FIG. 3 finally shows a cut detailed view of the sealing arrangement according to the invention in four different sealing positions, in which initially only one sealing element 30a lies against the shaft 20 (FIG. 3a), two sealing elements 30a, 30b lie against the shaft 20 (FIG. 3b), three sealing elements 30a, 30b, 30c lie against the shaft 20 (FIG. 3c) and finally all four sealing elements 30a, 30b, 30c, 30d lie against the shaft 20.

In the example that has been shown the shaft 20 has in the area of the sealing elements 30a, 30b, 30c, 30d a section (running from right to left in the drawing plane) with a shaft diameter that increases in steps.

In the starting position only the first sealing element 30a lies on the top step against the step-wise widened shaft 20 (FIG. 1a). At the same time the remaining sealing elements 30b, 30c, 30d are supported above the rotating shaft 20 without contacting the shaft 20.

By actuating the plurality of positioning means 60 (shown here as a screw that has screw action with a hole with an inside thread) the housing component 10 can be shifted parallel to the longitudinal axis of the shaft 20 until the sealing element 30b adjacent to the first sealing element 30a lies on its step.

By further actuating the positioning means 60 also the further sealing means 30c and the last sealing means 30d can be pushed onto the respective steps provided for them so that all sealing means 30a, 30b, 30c, 30d shown in the example lie against the shaft 20.

A particularly advantageous embodiment of the invention can be achieved if—as shown in FIG. 4 —the (annular) housing component 10 has an outside thread that can be screwed with an inside thread provided on another housing component. To shift the sealing arrangement in the axial direction of the shaft 20, preferably hydraulically movable bolts 100 can be provided preferably at the output or the input, e. g. at the hub 90 of the rotor of a wind power plant, that can be moved from a first position (see FIG. 4a) into the positioning means 60 designed as simple holes (see FIG. 4b) so that the housing component 10 co-rotates with the input or the output and is shifted along the longitudinal direction of the shaft 20.

Here the thread is preferably designed such that on rotating the housing components 10 clockwise or counter-clockwise the sealing elements 30a, 30b, 30c, 30d are shifted from a first position into a further position in which at least one further sealing element 30b, 30c, 30d lies against the shaft 20.

Using this particularly preferred embodiment it is also in particular possible to rotate the housing component 10 out of the housing by rotating and to insert it into the housing and this therefore simplifies precise assembly of the components, a further sealing element 110 protecting the previously presented, particularly preferred mechanism from contamination.

FIG. 5 finally shows three shafts 20, differently designed according to the invention. FIG. 5A shows a simply stepped design of the shaft 20 with a shaft diameter that tapers in the longitudinal direction of the shaft 20 from left to right for each step S1, S2, S3, S4. Here the shoulders between the steps S1, S2, S3, S4 are rounded off to enable a contacting that is as smooth as possible, of the sealing elements 30a, 30b, 30c, 30d (not shown in this illustration) with the shaft 20 and to prevent the sealing elements being damaged by sharp-edged shoulders.

FIG. 5B shows that at least the three steps S1, S2, S3 shown on the left side have a conical design in a part-area. The conic part-area of the steps S1, S2, S3 is in particular situated in that area of the steps S1, S2, S3 that is in the movement direction of the sealing elements 30a, 30b, 30c, 30d so that on shifting the sealing elements 30a, 30b 30c, 30d the respective sealing element 30a, 30b, 30c is pushed onto the conic area of step S1, S2, S3 and is placed under tension. This is to achieve that even slightly worn sealing elements 30a, 30b, 30c can continue to exert their sealing function by being pressed gently against the shaft 20. The last step S4 however preferably has no conic part-area since it makes sense to replace all sealing elements 30a, 30b, 30c, 30d when the associated sealing element 30d is worn.

FIG. 5C shows a further shaft 20 with steps S1, S2, S3 designed as a pedestal. Here the pedestals S1, S2, S3 arranged at a distance from the shaft axis that decreases from left to right in the drawing, are designed as running surfaces for the correspondingly assigned sealing elements 30a, 30b, 30c. If the sealing elements 30a, 30b, 30c, 30d are now shifted in the drawing from right to left, for example the sealing element 30a used first (arranged on the left side) is pushed from the pedestal S1 so that it no longer contacts the shaft 20 and does not exert any sealing function (any longer). But then the sealing element 30b following next after the sealing element 30a is placed on the pedestal S2 that follows next and is placed lower, by axially shifting sealing elements 30a, 30b, 30c, 30d. If also this sealing element 30b is worn, it is taken from the pedestal S2 and the next sealing element 30c is brought into contact with its pedestal S3.

However the design of the pedestals S1, S2, S3 can also be such that each sealing element 30a, 30b, 30c is in contact with the pedestal S1, S2, S3 for in each case two cycles and is not taken from the pedestal until a further cycle.

Assuming a life of four to five years for a sealing element designed as a sealing lip, the entire life of the inventive sealing arrangement amounts to approximately 20 years at most.

1. A sealing arrangement, comprising a housing component, a shaft at least partially accommodated by the housing component, and a plurality of sealing elements, which can be moved along the longitudinal axis of the shaft, for sealing the intermediate space between the housing component and the shaft,
characterized in that
the shaft comprises a section that extends in the longitudinal direction of the shaft and has a shaft diameter that is tapered in steps, and
the sealing elements can be moved from a first position, in which a first sealing element lies against a first step, to further positions, in which additionally at least one further sealing element lies against in each case one further step.

2. The sealing arrangement according to claim 1, characterized in that the number of steps corresponds to the number of the sealing elements.

3. The sealing arrangement according to claim 1, characterized in that the number of positions corresponds to the number of sealing elements.

4. The sealing arrangement according to claim 1, characterized in that the sealing elements are arranged such that they can be moved together.

5. The sealing arrangement according to claim 1, characterized in that at least one step is at least partly of conic design.

6. The sealing arrangement according to claim 1, further comprising channels feeding and discharging a lubricant between the sealing elements.

7. The sealing arrangement according to claim 1, characterized in that at least some of the steps are designed as a pedestal.

8. The sealing arrangement according to claim 1, characterized in that the distance between two steps and the distance between two neighbouring sealing elements approximately corresponds to half the distance between the preceding steps or a preceding pair of the sealing elements.

9. The sealing arrangement according to claim 1, characterized in that the sealing elements are connected to a common carrier.

10. The sealing arrangement according claim 9, characterized in that the sealing elements and the carrier are of integral design.

11. The sealing arrangement according to claim 1, characterized in that the sealing elements are of equal lengths and are arranged in a direction of an increase in diameter of the shaft with a diminishing distance from an axis of the shaft.

12. The sealing arrangement according to claim 1, characterized in that the housing component is formed from two rings that are releasably connected to each other by fastenings means and form a receptacle for the sealing elements.

13. The sealing arrangement according to claim 1, characterized in that the housing component has positioning means for positioning the housing component in a housing.

14. The sealing arrangement according to claim 1, characterized in that the housing component has an external thread.
